(19) United States
(12) Patent Application Publication
(10) Pub. No.: US 2008/0118604 A1
(43) Pub. Date: May 22, 2008

(54) Articles of commerce comprising stomach friendly coffee products

(75) Inventors: Christopher Michael Mickowski, Loveland, OH (US); Gerhard Norbert Zehentbauer, Okeana, OH (US); Ralph Lawrence Helmers, Cincinnati, OH (US); David Vincent Zyzak, Mason, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/601,327

(22) Filed: Nov. 17, 2006

(51) Int. Cl. A23F 5/10; A23F 5/00

(52) U.S. Cl. 426/87

(57) ABSTRACT

Articles of commerce comprising a container including a coffee product containing Robusta and Arabica coffee roasted to an overall Hunter L color of no darker than about 19L and a message communicating that the coffee is stomach friendly.

### FIELD OF THE INVENTION

Exemplary embodiments of the present invention generally relate to articles of commerce including a container comprising a coffee product containing Robusta and Arabica coffee roasted to an overall Hunter L color of no darker than about 19L and a message communicating that the coffee is stomach friendly.

### BACKGROUND OF THE INVENTION

With over 400 billion cups consumed every year, coffee can be considered the world's most popular beverage. Coffee products are manufactured from coffee beans, which are the seeds of cherries that grow on coffee trees in a narrow subtropical belt around the world. There are many coffee varieties, however, it is generally recognized that there are two primary commercial coffee species: Coffea arabica (herein “Arabica(s)”) and Coffea canephora var. robusta (herein “Robusta(s)”). Coffees from the species arabica may be described as “Brazils,” which come from Brazil, or “Other Milds” which are grown in other premium coffee producing countries. Premium Arabica countries are generally recognized as including Colombia, Guatemala, Sumatra, Indonesia, Costa Rica, Mexico, United States (Hawaii), El Salvador, Peru, Kenya, Ethiopia and Jamaica. Coffees from the species canephora var. robusta are typically used as a low cost extender or as a source of additional caffeine for Arabica coffees. These Robusta coffees are typically grown in the lower regions of West and Central Africa, India, South East Asia, Indonesia, and Brazil.

While each of the previously mentioned coffee bean types has its own unique characteristics, all coffees have some shared characteristics which help make it a popular beverage among consumers. For example, some consumers drink coffee because of the caffeine content, which can provide a “boost” to help them start their day awake and alert, while other consumers drink coffee because they simply enjoy the taste.

Unfortunately, not all consumers are able to enjoy coffee beverages because they suffer from heartburn or gastrointestinal (GI) issues, such as irritable bowel syndrome (IBS), ulcers or indigestion, which may restrict or even prevent their coffee consumption as coffee contains irritant compounds which can lead to worsening of these health concerns, as explained below.

There are three phases of stomach activity with respect to gastric secretions in the digestive process. These phases are known as the Cephalic phase, the Gastric phase and the Intestinal phase. The Cephalic phase is where sensory cues and anticipation trigger gastric secretions. Approximately 30-50% of gastric secretions occur during this phase. The Gastric phase is where food and substances actually make contact with the stomach. Not surprisingly, this phase accounts for about 40-50% of gastric secretions. The Intestinal phase is where food and substances exit the stomach and thus, this phase accounts for only about 5% of gastric secretions. Therefore, without intending to be limited by theory, it is believed that products aimed at reducing gastric secretions during the Cephalic phase, and particularly, the Gastric phase, may lead to a lessening of stomach irritation.

More specifically, during the Cephalic phase, the smell, sight or taste of food or drink can stimulate the nervous system, triggering the mouth to secrete saliva and the stomach to secrete gastric juices, both of which help break down the food and drink consumed. The Cephalic phase continues until the food or drink is swallowed and accounts for up to about 50% of secretion stimulation. Foods and drinks with a bitter taste, such as coffee, can cause an increase in the secretion of saliva and gastric juices as a result of stimulation of the taste buds. Therefore, reduction in bitterness may be an important factor in reducing gastric secretions during the Cephalic phase.

The Gastric Phase of the digestive process begins when the food enters the stomach, and as previously described, this phase accounts for about 40-50% of gastric secretions. During this phase, the presence of certain phenols, namely pyrochatechol (catechol), hydroquinone and pyrogallol, have been reported to be associated with stomach irritation from coffee. See EP 0755631 B1 and Elrich, A., Luicker, P. F., & Schaefer, A. (1999). Effect of Processed and Non-Processed Coffee Samples on Gastric Potential Difference. Arzneimittel-Forschung Drug Research. 49 (II), No. 7, 4-15. Since a number of similar compounds are produced through coffee roasting, it is possible that these phenols are markers for a variety of compounds that could be irritating. Thus, reduction in irritating compounds or irritant levels may also be an important factor in lessening gastric secretions.

Irritants are present in different concentrations in Arabica and Robusta coffee products. Arabica coffee products are generally considered to be higher quality coffees, and therefore, produce better tasting coffee beverages. This may be attributed, at least in part, to the fact that Arabica coffees naturally have lower levels of irritants, such as those described previously. In contrast, Robusta coffee products tend to deliver more negative flavor characteristics, such as bitter and harsh flavor notes. Again, this may be attributed to the fact that Robusta coffees contain significantly higher concentration of irritants. As a result, many products claiming to be gentle on the stomach contain 100% Arabica coffee. By reducing both bitterness characteristics and phenol content through elimination of Robusta coffees, Arabica coffee products may thereby reduce stomach irritation in both the Cephalic and Gastric phases, while providing a flavorful, well-balanced coffee beverage.

While 100% Arabica coffee products may be able to offer some relief to consumers having GI concerns, Arabica coffee is considered a “premium” coffee, and is therefore the more expensive coffee species. Thus, consumers suffering from stomach conditions must be willing to pay a premium price.

Additional research indicates that gastric irritation may also be reduced by altering coffee processing. For instance, it is known that coffee that is roasted to a lighter roast color can have a less bitter or harsh flavor than darker roasted coffee of the same species. This can be particularly true for Robusta coffees, which are considered to comprise more bitter and harsh flavors than Arabica coffees roasted to the same overall roast color. However, lightly roasting generally results in coffee products having a weak and unbalanced flavor that is not amenable to most consumers. Therefore, light roasting is generally avoided.

Steam treating coffee beans has also been proposed as a method to reduce irritants in coffee beans. See EP 0755631. However, such steaming processes can often be complex and expensive. The costs of carrying out steaming processes are then passed on to consumers who will pay more for steam treated products at the point of sale. Furthermore, it is known that the steaming can remove some of the flavor components of the coffee, thereby resulting in coffee products which may lack the flavor characteristics desired by the consumer.

Moreover, the application of acid-reducing coatings to the coffee beans has been used to try to lessen stomach irritation. See, U.S. Pat. No. 6,669,979. While such products may provide a degree of relief to consumers having GI issues, some consumers prefer a coffee product that is free of additives and is 100% coffee.

Additionally, the decaffeination of coffee is can naturally reduce some of the irritants present in coffee by removing some irritant precursors, as explained in detail herein below. Also, as caffeine itself may be considered an irritant, decaffeination may also be used to lessen stomach upset. However, many consumers with GI issues desire the “boost” provided by consuming a caffeinated beverage, and thus, do not want decaffeinated products, even if such products are more easily consumed. Furthermore, similar to steam treated coffee, decaffeination can also remove flavor components in addition to caffeine, which can result in products having a flavor unacceptable to consumers. Moreover, while recaffeination processes may be used to add caffeine back into decaffeinated products and provide a caffeinated coffee that is gentle on the stomach, like steaming, recaffeination processes can often be complex and expensive, thereby resulting in higher priced products.

Therefore, there remains a need for a caffeinated, 100% coffee product comprising both Robusta and Arabica coffee, and which has a full and balanced flavor and that does not result in stomach irritation to those consumers having GI, or other related, issues.

### SUMMARY OF THE INVENTION

Embodiments of the present invention relate to articles of commerce comprising a container including a coffee product containing Robusta and Arabica coffee roasted to an overall Hunter L color of no darker than about 19L and a message communicating that the coffee is stomach friendly.

Embodiments of the present invention also relate to articles of commerce comprising a container including a coffee product containing at least about 5% of a Robusta coffee, at least about 60% of an Arabica coffee, a message communicating that the coffee is stomach friendly, wherein the coffee comprises an overall Hunter L color of no darker than about 19 L.

Embodiments of the present invention also relate to articles of commerce comprising a container including a coffee product containing at least about 5% of a Robusta coffee, at least about 60% of an Arabica coffee, a catechol level of less than about 120 ppm, and a message communicating that the coffee is stomach friendly.

### DETAILED DESCRIPTION OF THE INVENTION

Exemplary embodiments of the present invention generally relate to articles of commerce comprising a container comprising a stomach friendly coffee product and a message communicating the same.

### A. Definitions

As used herein, the term “Arabica” means any coffee from the species Coffea arabica.

As used herein, the term “balanced” means flavor attributes are optimized to their targeted strength levels.

As used herein, the term “caffeinated” means that the coffee product comprises about 5000 ppm caffeine or greater, by weight of the coffee product.

As used herein, the term “coffee blend” means a mixture comprising green Robusta and Arabica beans prior to roasting.

As used herein, the term “coffee product” means a caffeinated mixture comprising Robusta and Arabica beans, either whole or ground, after roasting is complete.

As used herein, the term “initial Hunter L color” means the roast color of the coffee product immediately after the roasting process is complete.

As used herein, the term “light(ly) roasting” or “light(ly) roasted” means that the coffee product has been roasted to an overall Hunter L color of no darker than about 19 L.

As used herein, the term “overall Hunter L color” means the roast color of the coffee product approximately twenty-four hours after the roasting process is complete.

As used herein, the term “container” means any package suitable for holding a coffee product in accordance with the present invention. Examples of containers acceptable for use herein, include, but are not limited to, bags, canisters, boxes, bowls, plates, tubs, and cans.

As used herein, the term “Robusta” means any coffee from the species Coffea canephora var. robusta.

As used herein, the term ” stomach friendly” means coffee products that may be considered easy on the stomach by consumers because such products produce smooth, rather than bitter or harsh, sensory qualities. Moreover, stomach friendly coffee products can result in less stomach discomfort and/or less gastric irritation for consumers when compared to non-stomach friendly varieties, especially those consumers having gastric related maladies. Also, stomach friendly coffee products may allow consumers to consume more cups of the coffee product without stomach upset than they can with non-stomach friendly varieties. Effective messages for communicating a stomach friendly benefit include, but are not limited to, “Gentle on the stomach,” “Easy on the stomach,” “Specially processed to be gentle (or easy) on the stomach,” “Specially roasted to be gentle (or easy) on the stomach,” “Less irritating on the stomach,” “Reduced irritants,” “May be consumed more frequently by consumers having stomach concerns,” and combinations thereof.

All Hunter L colors are based on ground, rather than whole bean, coffee unless specified otherwise.

### B. Articles

Embodiments of the present invention generally relate to articles of commerce comprising a container comprising a stomach friendly coffee product and a message communicating the same.

As previously described, there are many coffee species, however, Arabicas and Robustas are recognized as the two primary commercial coffee species. Any suitable coffee beans, or mixtures of the various species of beans, can be used in embodiments of the present coffee products. Moreover, the beans may be caffeinated, decaffeinated and/or partially decaffeinated, as long as the coffee product comprises 5000 ppm of caffeine or more by weight of the coffee product, thereby resulting in a caffeinated coffee product in accordance with exemplary embodiments of the present invention. In one embodiment, the coffee product can comprise a blend of Arabica and Robusta coffee beans. More particularly, the coffee product may comprise from at least about 5% to about 40% Robusta coffee, and at least about 60% to about 95% Arabica coffee, by weight of the coffee product. In another embodiment, the coffee product may comprise from about 15% to about 30% Robusta coffee and from about 70% to about 85% Arabica coffee, by weight of the coffee product. In yet another embodiment, the coffee product may comprise from about 20% to about 30% Robusta coffee to about 70% to about 80% Arabica coffee, by weight of the coffee product.

The Robusta and Arabica coffee beans can be mixed together to produce the desired coffee blend, which is then ready for further processing, such as, roasting. The coffee blend herein may be roasted using any conventional roasting process known to those skilled in the art. As used herein, the term “roasting” includes any suitable thermal treatment of coffee beans to create flavors that are indicative of coffee. Suitable roasting techniques can include, but are not limited to, oven roasting, extrusion roasting, steam roasting (e.g., with no post roasting), infrared roasting, microwave roasting, di-electric/induction heating roasting, and combinations thereof. Typical roasting equipment and methods for roasting coffee beans are described, for example, in Coffee Recent Developments, Blackwell Science Ltd, Malden, Mass., (2001) pgs. 90-107. In general, the coffee blend is transported to a roaster where it is roasted at a temperature of between about 450-700° F., for from about 3 to about 15 minutes, or until the desired Hunter L roast color is achieved. As used herein, Hunter color is measured on a Hunter calorimeter from the Hunter CIE scale using roast and ground coffee products. See pages 985-95 of R. S. Hunter, “Photoelectric Color Difference Meter,” J. of the Optical Soc. of Amer., Volume 48 (1958).

Alternately, Robusta and Arabica coffee beans may be roasted separately and then blended after roasting (herein “BAR”) to provide a coffee product comprising the previously described portions of each coffee bean species. Blending after roasting may be used to allow each type of bean to be roasted to its optimum color for flavor development and irritant reduction. Because different coffee bean species can roast differently under the same roasting conditions, BAR processing can provide an alternate method by which to produce a coffee product having the desired blend and irritant characteristics. Thus, blending the two species of coffee beans together after roasting may be utilized to produce coffee products herein, as is explained in more detail herein below.

After roasting, and optionally blending, the resulting roasted coffee product may be processed further. More specifically, the coffee product can be reduced in particle size by cracking, chopping, dicing, macerating, grinding, flaking, or any other suitable method. Those skilled in the art will understand these and other methods by which to reduce the particle size of the roasted coffee beans if so desired.

Regardless of what point in the processing the two coffee bean species are blended, or how the coffee product is ground, it has been surprisingly discovered that lightly roasting the coffee may provide a coffee product having numerous exciting benefits. It has been surprisingly discovered that light roasting alone (i.e. without additional processing like the previously described steaming or coating) can be used to not only reduce bitterness, but also to provide reduced levels of the previously described irritant substances while still delivering a balanced and flavorful coffee product. These and other benefits are explained in greater detail herein below.

Specifically, it has been surprisingly discovered that, in addition to reduced bitterness, light roasting alone can provide reduced levels of irritant substances when compared to more darkly roasted coffee products as well as a balanced coffee product. As previously described, it is believed that catechol, hydroquinone and pyrogallol, which are present in coffee, may be associated with stomach irritation during the Gastric phase. Such compounds are not present in green coffee beans, but rather are formed as the result of the roasting process. Without intending to be limited by theory, it is believed that chlorogenic and dichlorogenic acids degrade under conventional roasting conditions to form caffeic and quinic acids, which in turn, further degrade to form catechol, hydroquinone and pyrogallol. See Leloup, V., Lovier, A. & Liardon, R. (1995) Degradation mechanism of chlorogenic acids during roasting. In: Proceedings of the 16^{th} ASIC Colloquium (Kyoto), pgs. 359-64, ASIC, Paris, France. Therefore, the darker the roast color of the coffee, the more degradation occurs and the more irritants are produced. Thus, it is believed that there may be a strong correlation between roast color and irritant level.

Therefore, embodiments of coffee products herein may comprise less than about 120 ppm catechol, and in one embodiment, less than about 115 ppm catechol. Likewise, embodiments of coffee products herein may comprise less than about 15 ppm hydroquinone, and in one embodiment, less than about 13 ppm hydroquinone. Moreover, embodiments of coffee products herein may comprise less than about 75 ppm pyrogallol. For an explanation on how the present irritant levels can be determined, see the Analytical Methods section herein, which provides an improved method for quantifying the catechol, hydroquinone and pyrogallol found in roast and ground coffee.

Additionally, because of the previously described benefits, it has been surprisingly discovered that Robusta coffee may be added to the coffee products herein. This is contrary to currently marketed stomach friendly coffee varieties, which generally contain 100% Arabica coffee. As previously described, Robusta coffees are higher in bitter flavor notes and irritants than Arabicas. Thus, Robustas are not generally used in stomach friendly coffees due to their tendency to increase the gastric response, which can lead to stomach discomfort. However, by using the light roasting processes described herein, a Robusta-Arabica coffee blend may be formulated that is gentle on the stomach. In particular, the light roasting reduces the degradation of chlorogenic acid to such a degree that even Robusta coffees, the green beans of which are higher in chlorogenic acid than the corresponding Arabica coffee, may be used presently to achieve a stomach friendly coffee product. An additional benefit realized by the inclusion of Robusta coffee in the embodiments described herein is that such Robusta-Arabica blends are less costly than 100% Arabica products.

Furthermore, because light roasting can reduce the bitter flavor notes and irritants that can result in gastric distress, it is also possible to have a fully caffeinated stomach friendly coffee. This is true in spite of the fact that Robusta coffees tend to have higher caffeine contents than Arabica varieties.

Therefore, in view of the above, in one embodiment, the coffee blend can be roasted to produce a coffee product having an initial Hunter L color of no darker than about 20 L. In another embodiment, the coffee blend can be roasted to produce a coffee product having an initial Hunter L color of no darker than about 21 L. In yet another embodiment, the coffee blend can be roasted to produce a coffee product having an initial Hunter L color of no darker than about 22 L. As is known to by those skilled in the art, within about twenty-four hours after the roasting process is complete, and as a result of natural processes, the roast color of the coffee product can become darker by about 1 L roast color. Therefore, in accordance with the present invention, the coffee product can have an overall Hunter L color of no darker than about 19 L. In another embodiment, the coffee product can have an overall Hunter L color of no darker than about 20 L. In yet another embodiment, the coffee product can have a Hunter L color of no darker than about 21 L.

Alternately, if BAR processing is utilized, in one embodiment, Robusta coffee beans may be roasted to an initial Hunter L color of no darker than about 21 L. In another embodiment, Robusta beans may be roasted to an initial Hunter L color of no darker than about 22 L. Likewise, in one embodiment, Arabica coffee beans may be roasted to an initial Hunter L color of no darker than about 19 L. In another embodiment, Arabica coffee beans may be roasted to an initial Hunter L color of no darker than about 20 L. Once roasted, the two species may be blended together in the proportions described previously to provide coffee products having an overall Hunter L color as set forth above.

Now that the coffee beans have been roasted and ground the coffee product is ready for packaging. The coffee product may be packaged into any container known to those skilled in the art. Suitable containers include, but are not limited to, bags, canisters, boxes, bowls, plates, tubs, and cans.

In addition to the coffee product set forth previously, articles in accordance with the present invention may further include a message. The message associated with the container informs the consumer that the roasted coffee product contained therein is stomach friendly as defined above. Effective messages for communicating a stomach friendly benefit include, but are not limited to, “Gentle on the stomach,” “Easy on the stomach,” “Specially processed to be gentle (or easy) on the stomach,” “Specially roasted to be gentle (or easy) on the stomach,” “Less irritating on the stomach,” “Reduced irritants,” “May be consumed more frequently by consumers having stomach concerns,” and combinations thereof.

The message can be printed material attached directly or indirectly to the container, attached directly or indirectly near the container, or alternatively can be a printed, electronic, or broadcast message associated with the container. Suitable messages include, but are not limited to, messages that communicate that the coffee product within the container is “stomach friendly,” “gentle on the stomach,” and like notions.

### Analytical Methods

Parameters used to characterize elements of the present invention are quantified by particular analytical methods. These methods are described in detail as follows.

### Scope

### Quantification of di-and tri-hydroxybenzenes (i.e. catechol, hydroquinone and pyrogallol) in Roast and Ground Coffee.

### Principle

1. A sample of coffee grounds is placed into a beaker.

2. Deuterium-labeled analogues of the analytes are added as internal standards and the grounds are extracted with boiling water.

3. Together with their deuterium-labeled analogues, the di-and tri-hydroxybenzenes present in the aqueous extract are then derivatized with acetic anhydride and subsequently isolated by stir bar sorbtive extraction (Gerstel Twister).

4. After desorbing onto a gas chromatographic column, the compounds are analyzed by mass spectrometry.

5. Based on the differences in their molecular mass, the amount of catechol, hydroquinone and pyrogallol in the sample is quantified by integrating their individual mass response relative to that of their corresponding labeled internal standard.

### Validation

Accuracy

To account for differences in the mass response, a response factor is determined each day of analysis for each analyte occurring with its labeled analogue in a ratio between 1:3 to 3:1. The response factors for catechol, hydroquinone and pyrogallol are determined after a 25-fold dilution of the original extract prior to stir bar sorbtive extraction (Gerstel Twister

Based on the results from 10 independent data sets obtained on different days, the average response factors including standard deviation are calculated to be:

| | Response | |
|---|---|---|
| Analyte | Factor | % RSD |
| catechol - d₆-catechol: | 1.0081 | <3.0 |
| hydroquinone - d₆-hydroquinone: | 0.9383 | <2 |
| pyrogallol - d₆-pyrogallol: | 0.8946 | <5.5 |

Precision

Based on 11 quantifications of a coffee control sample performed in duplicate over a period of two months, the average standard deviation of the mean value in each analysis is:

Catechol: 091%

Hydroquinone: 0.95%

Pyrogallol: 2.94%

### Apparatus

| Apparatus | Specifications |
|---|---|
| Pipettor, 10–100 μL, variable volume | Accurate to within ±2.5% |
| Pipettor, 100–1000 μL, variable volume | Accurate to within ±1.6% |
| 6890 Gas Chromatograph, Agilent | |
| Cooled Injection System (CIS II), Gerstel | |
| Thermal Desorption Unit for Twister, | |
| Gerstel | |
| 5973 Mass Spectrometer, Agilent | |
| MPS II Autosampler, Gerstel | |

### Reagents

| Reagent | Grade |
|---|---|
| Water | Deionized by Milli-Q system |
| Sodium bicarbonate | ACS-grade; 99.7–100.3% |
| Acetic anhydride | ACS-grade, 98% |
| Acetic acid, glacial | 98+ % |
| Catechol | 99+ % |
| Pyrogallol | 99% |
| hydroquinone | 99% |
| d₆-hydroquinone | 98+ % |
| d₆-catechol | specifically synthesized |
| d₆-pyrogallol | specifically synthesized |

### Safety

Users of this method refer to the individual laboratory's safe practices that are applicable for this method.

### Procedure

### Preparation of Special Reagents

### Preparation of Standards

(a) Non-Labeled Standards

Stock Standard Solutions: Individually weigh about 50 mg of catechol, hydroquinone and pyrogallol into separate volumetric flasks (100 mL) and dissolve in water (100 mL) containing 1000 ppm acetic acid. Record concentration

Working Standard Solution

Catechol: Use stock solution prepared above

Pyrogallol: Dilute stock solution 1:2 by mixing 5 mL stock solution with 5 mL water containing 1000 ppm acetic acid resulting in a final concentration of about 250 ug/mL. Record final concentration

Hydroquinone: Dilute stock solution 1:5 by mixing 1 mL stock solution with 4 mL water containing 1000 ppm acetic acid resulting in a final concentration of about 100 ug/mL. Record final concentration

### (B) Deuterium-Labeled Standards

Stock Standard Solutions: Individually weigh about 50 mg of d₆-catechol, d₆-hydroquinone and d₆-pyrogallol into separate volumetric flasks (100 mL) and dissolve in water (100 mL) containing 1000 ppm acetic acid. Record concentration

Working Standard Solution

d₆-Catechol: Use d₆-catechol stock solution prepared above

d₆-Pyrogallol: dilute d₆-pyrogallol stock solution 1:2 by mixing 50 mL stock solution into a 100 mL volumetric flask, then add water containing 1000 ppm acetic acid to volume resulting in a final concentration of about 250 ug/mL. Record final concentration

d₆-Hydroquinone: Dilute stock solution 1:5 by mixing 1 mL stock solution with 4 mL water containing 1000 ppm acetic acid resulting in a final concentration of about 100 ug/mL. Record final concentration

Divide labeled working solutions into aliquots of 5 ml, place them into amber vials and store them at −20° C. Solutions are stable for at least 6 months at −20° C.

### Preparation of Equipment

Prior to analysis the sorbtive stir bars (Twister) are conditioned to remove any residual material from their adsorptive coating that might interfere with the analysis. The stir bars are placed as groups of three into autosampler desorption tubes, then inserted into the thermal desorption unit (TDU) and baked at 275° C. for 15 min under a stream of helium.

### Preparation of Responsefactor Mixtures

Prepare two sets consisting of three individual mixtures each. For one set, place 50 mL of Milli-Q water containing 50 ul into three individual headspace vials (100 mL volume) and subsequently, add each labeled and unlabeled working standard solution in the amounts indicated in Table 1. Shake flasks to equilibrate samples.

TABLE 1
Amount (uL) of working standard solutions added into 50 mL water

| Flask # | d₆-hydroquinone | d₆-catecol | d₆-pyrogallol | catechol | pyrogallol | hydroquinone |
|---|---|---|---|---|---|---|
| 1 | 100 | 100 | 100 | 30 | 30 | 30 |
| 2 | 100 | 100 | 100 | 100 | 100 | 100 |
| 3 | 100 | 100 | 100 | 300 | 300 | 300 |

Add 1.5 g sodium bicarbonate to each solution and dissolve within 1 min while swirling. Finally, add 1.5 ml acetic anhydride and swirl flask for even distribution. Shake infrequently for degassing

Derivatization is allowed to occur for about 1 h. Subsequently, the samples are degassed by sonication for about 15 min

### Preparation of Samples

### Extraction of di- and trihydroxybenzenes.

Bring water to a boil. Add 1.0 g of coffee grounds into a beaker (140 mL), record precise weights of coffee. Add 200 ul of each labeled standard solution (dr-catechol, 0.5 mg/mL; d₆-pyrogallol, 0.25 mg/mL; d₆-hydroquinone 0.1 mg/mL), then add 70 mL boiling water, and boil for 10 minutes on hot plate.

Transfer hot solution into a 100 ml volumetric flask by filtering through a filter paper (Whatman #4) to remove grounds. Rinse beaker and filter paper with hot water (30 ml) Let cool down to room temperature in a water bath then add water to volume.

### Derivatization of di- and trihydroxybenzenes

Divide the sample into two aliquots (50 mL) and transfer them into two headspace glass vials (volume 100 mL). Then add 1.5 g sodium bicarbonate to each sample and dissolve within 1 minute while swirling. Finally, add 1.5 ml acetic anhydride and swirl flask for even distribution. Shake infrequently for degassing.

Derivatization is allowed to occur for about 1 h. Subsequently, the samples are degassed by sonication for about 15 min

### Sorbtive Stir Bar Extraction:

Dilute each response factor mixture and coffee sample 1:25 by pipetting an aliquot of 4 mL into a 100 mL volumetric flask and add acidified water to volume. Then, divide the diluted sample into two aliquots (50 mL) and transfer them into two headspace glass vials (volume 100 mL). Add a Twister stir bar to each vial and allow to stir for 40 min at 400 rpm. Subsequently, take out the stir bar, rinse with 2 mL water (Milli-Q), dry with a chem-wipe and place into a desorption tube (Gerstel).

### Parameters for Conditioning the Sorbtive Stir Bars Prior to Analysis:

a.) Parameters of the Thermal Desorption Unit (TDU, Gerstel):
Initial Temp.: 30° C.
Initial Time: 0.0 min.
Delay Time: 0.5 min.
1^{st} Rate: 60° C.
1^{st} final Temp: 275° C.
1^{st} final Time: 15 min.

b.)Parameters of the Cooled Injection System (CIS, Gerstel):
SlitMode: Split, cryo-cooling: off
Splitless Time: 1 min.
Purge Time: 0.5 min.
Equili. Time: 2 min.
Initial Temp.: 260° C.
Initial Time: 0.0 min.
1^{st} Rate: 12° C.
1^{st} final Temp: 260° C.
1^{st} final Time: 3 min.

### Instrumental Operation

Desorb analytes under the following conditions:

### TDU Parameters:

Flow mode: splitless

Initial Temp.: 30° C.

Initial Time: 0.0 min.

Delay Time: 1 min.

1^{st} Rate: 60° C.

1^{st} final Temp: 200° C.

1^{st} final Time: 5 min.

### CIS Parameters:

Split Mode: Split, cryo-cooling: on

Splitless Time: 1 min.

Purge Time: 0.5 min.

Equili. Time: 1.2 min.

Initial Temp.: −120° C.

Initial Time: 0.20 min.

1^{st} Rate: 12° C.

1^{st} final Temp: 250° C.

1^{st} final Time: 3 min.

Analysis is performed by GC-MS under the following conditions:

### GC Parameters:

Column: DB-5 MS, 30 m×0.25 mm; 1 um film thickness

Carrier gas: helium, with a constant flow rate of 2 mL/min

Initial oven temperature: 100° C.

1^{st} Rate: 10° C.

1^{st} final Temp: 200° C.

1^{st} final time: 0 min.

2^{nd} Rate: 15° C.

2^{nd} final Temp: 250° C.

2^{nd} final Time 5 min.

### MS Parameters:

Operation mode: electron impact (EI) at 70 eV

Acquisition mode: scan, 40-250 mass units

Solvent delay: 2 min.

MS Quad temperature: 150° C.

MS Source temperature: 230° C.

### Calculations

Response Factor:

$${F}_{R} = \frac{{m}_{u} \times {I}_{d}}{{m}_{d} \times {I}_{u}} {F}_{R} = \frac{{m}_{u} \times {I}_{d}}{{m}_{d} \times {I}_{u}}$$

F_{R}=Response Factor
mᵤ=amount in ug of unlabeled analyte in calibration solution
m_{d}=amount in ug of labeled standard in calibration solution
Iᵤ=Peak area of unlabeled analyte ion (m/z) in calibration solution
I_{d}=Peak area of labeled standard ion (m/z) in calibration solution

Quantification:

$${conc}_{u} ( ug \text{/} g or ppm ) = \frac{{m}_{d} \times {I}_{u} \times {F}_{R} \times {m}_{cof}}{{I}_{d}}$$

$${conc}_{u} ( μg \text{/} g or ppm ) = \frac{{m}_{d} \times {I}_{u} \times {F}_{R} \times {M}_{cof}}{{I}_{d}}$$

concᵤ=Concentration of unlabeled analyte in ug/g or ppm
m_{d}=amount in ug of labeled standard added to coffee prior to extraction
Iᵤ=Peak area of unlabeled analyte ion (m/z) in sample
F_{R}=Response Factor
M_{cof}=amount of coffee grounds in g used for extraction
I_{d}=Peak area of labeled standard ion (m/z) in calibration solution

### Reporting of Results

Results are reported as ug per gram of coffee grounds or ppm

### REFERENCES

Synthesis of deuterium-labeled catechol and pyrogallol was performed according to Tuck et al. “A simple procedure for deuteration of phenols”. Journal of Labeled Compounds and Radiopharmaceuticals (2000) 43, 817-823.

### EXAMPLES

### Example 1

Green Robusta coffee beans are blended with green Arabica beans to produce a coffee blend comprising about 25% Robusta and about 75% Arabica coffee beans. The coffee blend is transported to a hot air roaster and roasted at a temperature of about 630° F. for about 160 seconds to obtain a coffee product having an initial Hunter L color of about 21 L. The beans are allowed to cool and after about 24 hours, the coffee product has an overall Hunter L color of about 20 L. Once cool, the coffee product is ground to produce a roast and ground coffee product.

The coffee product is packaged into a container having a message stating that the coffee product is “Specially processed to be easy on the Stomach.” After consuming a cup of the stomach friendly coffee, a consumer having gastric concerns expresses experiencing less stomach irritation than he normally would after consuming a cup of a non-stomach friendly coffee product.

### Example 2

Green Robusta coffee beans are transported to a hot air roaster and roasted at a temperature of about 420° F. for about 170 seconds to obtain an initial Hunter L color of about 23 L. Similarly, green Arabica coffee beans are transported to a separate hot air roaster and roasted at a temperature of about 423° F. for about 150 seconds to obtain an initial Hunter L color of about 20 L. The beans are allowed to cool and after about 24 hours, the roasted Robusta beans have a Hunter L color of about 22 L while the roasted Arabica beans have a Hunter L color of about 19 L. Once cool, about 40% of the roasted Robusta beans are blended with about 60% of the roasted Arabica beans and the resulting coffee product is ground to produce a roast and ground coffee product having an overall Hunter L color of about 20.2 L.

The coffee product is packaged into a container having a message stating that the coffee product is “Gentle on the Stomach.” After consuming several cups of the stomach friendly coffee, a consumer having gastric concerns expresses experiencing less stomach irritation than she normally would after consuming the same amount of a non-stomach friendly coffee product.

When analyzed using the Analytical Methods described herein, the stomach friendly coffee product is found to have less than about 120 ppm catechol, less than about 15 ppm hydroquinone and less than about 75 ppm pyrogallol.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An article of commerce comprising:
a container including:
a coffee product comprising:
Robusta and Arabica coffee roasted to an overall Hunter L color of no darker than about 19 L; and
a message communicating that the coffee is stomach friendly.

2. The article of claim 1 wherein the coffee product comprises from about 5% to about 40% of the Robusta coffee and from about 60% to about 95% of an Arabica coffee.

3. The article of claim 1 wherein the coffee product is roasted to an overall Hunter L color of no darker than about 20 L.

4. The article of claim 1 wherein the coffee product comprises from about 15% to about 30% of the Robusta coffee and from about 65% to about 85% of the Arabica coffee.

5. The article of claim 1 comprising a catechol level of less than about 120 ppm, a hydroquinone level of less than about 15 ppm and a pyrogallol level of less than about 75 ppm.

6. An article of commerce comprising:
a container including:
a coffee product comprising:
at least about 5% of a Robusta coffee;
at least about 60% of an Arabica coffee; and
a message communicating that the coffee is stomach friendly wherein the coffee comprises an overall Hunter L color of no darker than about 19 L.

7. The article of claim 6 wherein the coffee product comprises from about 5% to about 40% of the Robusta coffee and from about 60% to about 95% of the Arabica coffee;

8. The article of claim 6 wherein the overall Hunter L color is no darker than about 20 L.

9. The article of claim 6 wherein the coffee product comprises from about 15% to about 35% of the Robusta coffee and from about 65% to about 85% of the Arabica coffee.

10. The article of claim 6 wherein the coffee product comprises from about 20% to about 30% of the Robusta coffee and from about 70% to about 80% the Arabica coffee.

11. The article of claim 6 comprising a catechol level of less than about 120 ppm.

12. The article of claim 6 wherein the overall Hunter L color is no darker than about 21L.

13. An article of commerce comprising:
a container comprising:
a coffee product including:
at least about 5% of a Robusta coffee;
at least about 60% of an Arabica coffee;
a catechol level of less than about 120 ppm; and
a message communicating that the coffee is stomach friendly.

14. The article of claim 13 wherein the coffee product comprises from about 5% to about 40% of the Robusta coffee and from about 60% to about 95% of the Arabica coffee;

15. The article of claim 13 wherein the coffee product comprises an overall Hunter L color of no darker than about 19 L.

16. The article of claim 13 comprising a hydroquinone level of less than about 15 ppm.

17. The article of claim 13 comprising a pyrogallol level of less than about 75 ppm.

18. The article of claim 13 wherein the coffee product comprises from about 20% to about 30% of the Robusta coffee and from about 70% to about 80% of the Arabica coffee.

19. The article of claim 13 wherein the coffee product comprises an overall Hunter L color of no darker than about 20 L.

20. The article of claim 13 wherein the overall Hunter L color is no darker than about 21 L.
